(19) United States
(12) Patent Application Publication
(10) Pub. No.: US 2025/0200498 A1
(43) Pub. Date: Jun. 19, 2025

(54) MONITORING GOODS DURING SHIPMENT

(71) Applicant: CARGOSHOT, INC., Carlsbad, CA (US)

(72) Inventors: Jon M. VAN WINKLE, Carlsbad, CA (US); Jeff P. JAEGER, Carlsbad, CA (US); Edward S. STREETER, Carlsbad, CA (US)

(21) Appl. No.: 18/849,381

(22) PCT Filed: Mar. 21, 2023
(86) PCT No.: PCT/US2023/015796

§ 371 Date: Sep. 20, 2024

Related U.S. Application Data
(60) Provisional application No. 63/321,834, filed on Mar. 21, 2022.

(51) Int. Cl. G06Q 10/0833

(52) U.S. Cl. CPC G06Q 10/0833

(57) ABSTRACT

A system for monitoring goods during shipment may include one or more user devices having one or more sensors configured to generate a condition record including a time value, a location value, and a physical condition of goods. The time and location values correspond to a predetermined route for transporting the goods between an origination point and a destination point. The system may also include a server device configured to receive a plurality of condition records from a plurality of user devices. Each condition record corresponds to a time value and a location value during transport of the goods along the predetermined route. The server also stores the plurality of condition records in association with the goods and each other. The server device may also provide at least a portion of information from the condition records in response to a request for transit information related to the goods.

### RELATED APPLICATION

The present application claims priority to U.S. provisional patent application No. 63/321,834 filed 21 Mar. 2022, which is incorporated herein by reference in its entirety.

### BACKGROUND

### Field of the Invention

The present disclosure generally relates to the shipping industry and more particularly relates to movement of goods from an origination point to a destination point.

### Related Art

The transportation of goods is a multi-billion dollar industry typically involving many different entities as goods move from manufacturers to distributors to retailers and ultimately to consumers. For example, a box of widgets may be manufactured by a first company, transported by truck to a second company for packaging, loaded onto a cargo ship for transport across an ocean, offloaded into a railcar and transported to a destination city and then moved onto another truck for delivery to a distribution warehouse. The widgets are then stored in the warehouse facility until they are individually shipped from the warehouse via truck to various retail locations.

As part of this process, the goods being transported are sometimes mishandled or damaged as they travel through the supply chain, for example, from manufacturer, to carrier, to warehouse, to another carrier and final unloading at a destination. Oftentimes it is not possible to determine where in the supply chain the goods were damaged or mishandled, and who is at fault for causing the damage/mishandling. This lack of information may cause problems when a downstream recipient attempts to be reimbursed for such damage/mishandling, either from a party suspected of causing the damage/mishandling or from one or more insurance companies.

In general, for an owner of goods being transported to make a claim against a carrier for lost or damaged goods, or for mishandling the goods (e.g., inadequate labeling, improper packaging or improper loading), the owner of the goods must typically show that the goods were provided to the carrier free of damages and/or properly labeled including proper blocking, bracing, wrapping or being properly secured to the trailer. The owner of the goods may also be required to show that the goods were damaged in some way while in transit prior to delivery or otherwise mishandled by the carrier, and the owner of the goods may also be required to quantify the damage or mishandling. Unfortunately, in these situations, there is usually no proof that the goods were provided in an undamaged condition and therefore no proof that the goods were damaged by a particular carrier in transit before being handed off to the next party in the supply chain. There is also usually no proof of when such damage or mishandling of the goods occurred. This lack of information about the status of goods in transit presents a significant challenge for the owners of the goods being shipped and unfortunately results in the owners of the goods bearing the cost of damaged goods and/or mishandled goods including fines and penalties and such costs are typically passed along to the consumer.

Additionally, a variety of fines and penalties may also be assessed on goods that are damaged or mishandled by parties in the supply chain. For example, a carrier may assess a fine on the owner of goods in transit if such goods are delivered to the carrier in a state that is non-compliant with their published vendor guide including missing a label, pallet too tall, improper placarding, improper label placement or over or short goods. These fines and penalties are not insignificant and can seriously impair the profitability of the owner of the goods, one or more carriers in the supply chain, and/or one or more logistics providers or manufacturers in the supply chain.

Accordingly, what is needed is a system and method that overcomes these significant problems found in the conventional transportation systems as described above.

### SUMMARY

Disclosed herein are solutions to the above described problems found in conventional transportation systems. In some aspects, the techniques described herein relate to a system for monitoring goods in transit, the system including: one or more user devices, each user device including one or more sensors configured to generate a condition record, the condition record including a time value, a location value, and a physical condition of goods, wherein the time value and the location value correspond to a predetermined route for transport of the goods between an origination point and a destination point; a server device, communicatively coupled with a plurality of user devices via one or more data communication networks, the server device configured to receive a first plurality of condition records from a plurality of user devices, each of the first plurality of condition records corresponding to a time value and a location value during transport of first goods on the predetermined route, the server device further configured to store the first plurality of records in association with the first goods and in association with each other; the server device further configured to provide at least a portion of information from the first plurality of condition records in response to a request for transit information related to the first goods.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 is a network diagram illustrating an example process for generating a condition record according to an embodiment of the invention;

FIG. 4 is a block diagram illustrating an example process for validating and storing condition records according to an embodiment of the invention;

FIG. 5 is a flow diagram illustrating an example process for responding to an inquiry about goods in transit according to an embodiment of the invention;

FIGS. 6-16 are screen shot diagrams illustrating an example user interface on a user system according to an embodiment of the invention;

FIGS. 17-24 are screen shot diagrams illustrating an example user interface on a server system according to an embodiment of the invention;

### DETAILED DESCRIPTION

Disclosed herein are systems, methods, and non-transitory computer-readable media for monitoring goods during transport. For example, one method disclosed herein allows for a plurality of user systems, each having one or more sensors, to generate a plurality of condition reports related to goods at different times and locations corresponding to a predetermined route for the goods during transport. The user systems send the condition reports to a server that stores the condition reports in association with the goods and with each other. The server also provides at least a portion of information from the condition records in response to a request for transit information related to the goods.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### 1. System Overview

### 1.1. Infrastructure

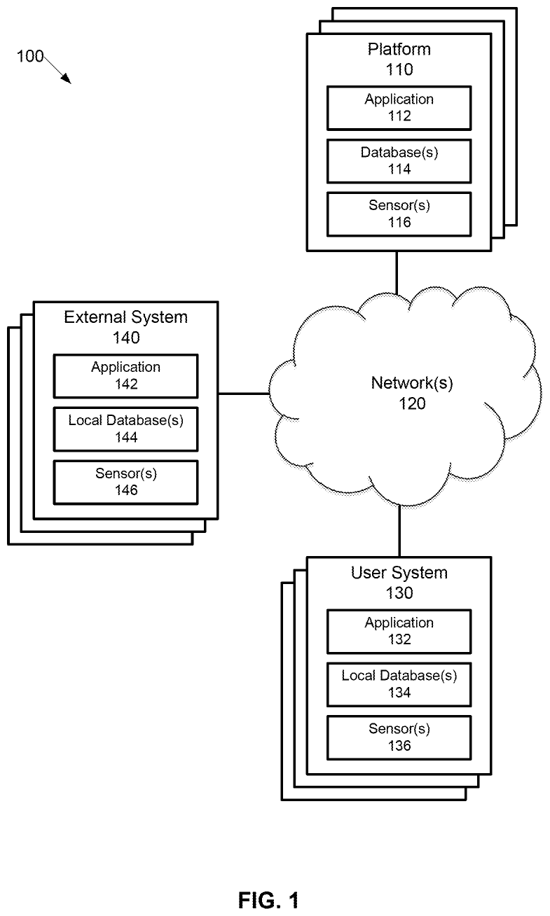

FIG. 1 illustrates an example infrastructure 100 in which one or more of the disclosed processes may be implemented, according to an embodiment. The infrastructure may comprise a platform 110 (e.g., one or more special purpose server computer devices) which hosts and/or executes one or more of the various functions, processes, methods, and/or software modules described herein. Platform 110 may comprise dedicated special purpose servers, or may instead comprise cloud instances, which utilize shared resources of one or more special purpose servers. These special purpose servers or cloud instances may be collocated and/or geographically distributed. Platform 110 may also comprise or be communicatively connected to a server application 112 and/or one or more databases 114 and/or one or more sensors 116. In addition, platform 110 may be communicatively connected to one or more user systems 130 (also referred to herein as “user devices”) via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks 120. For example, platform 110 may be connected to a subset of user systems 130 and/or external systems 140 via the Internet, but may be connected to one or more other user systems 130 and/or external systems 140 via an intranet. Furthermore, while only a few platforms 110 (with server application 112, database(s) 114, and sensor(s) 116), and only a few user systems 130 (with application 132, local database(s) 134, and sensor(s) 136), and only a few external systems 140 (with application 142, local database(s) 144, and sensor(s) 146) are illustrated, it should be understood that the infrastructure may comprise any number of platforms 110, user systems 130, and external systems 140.

User system(s) 130 may comprise any type or types of special purpose computing devices. Such special purpose user systems are capable of wired and/or wireless communication and may include, for example, certain desktop computers, certain laptop computers, certain tablet computers, certain smart phones, certain mobile phones, certain servers, certain head mounted displays, and/or certain other special purpose computing devices that are configured to carry out certain aspects of the systems and method disclosed herein. For example, in one aspect, user system 130 includes one or more sensors 136 that allow user system 130 to capture and store digital video and digital image content of goods in transit and generate a condition report that is sent to platform 110 via network 120.

Platform 110 may comprise certain special purpose servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130, external system 140, or server application 112 executing on platform 110 may submit data (e.g., user data, form data, etc.) to be stored in database(s) 114, and/or request access to data stored in database(s) 114. A variety of database implementations may be utilized, including without limitation MySQL™, Oracle™, IBM™, Microsoft SQL™, Access™, PostgreSQL™, and the like, including cloud-based databases and proprietary databases that are special purpose databases when configured to carry out certain aspects of the systems and method disclosed herein. In one aspect, data may be sent to platform 110, for instance, using the POST request supported by HTTP, via FTP, and/or the like. This data, as well as other requests, may be handled, for example, by server-side web technology, such as a special purpose servlet or other special purpose software module (e.g., comprised in server application 112), executed by platform 110 and configured to carry out certain aspects of the systems and method disclosed herein.

Platform 110 may further comprise, be communicatively coupled with, or otherwise have access to one or more sensor(s) 116. For example, platform 110 may comprise a camera 116 that is configured to capture still digital images and digital video content and store the digital media content in database 114. Additionally, platform 110 may comprise a sensor 116 that is configured to capture ambient temperature, humidity, or moisture content of goods or of a container holding goods and provide the sensor information to application 112 for processing.

In embodiments in which a web service is provided, platform 110 may receive requests from external system(s) 140, and provide responses in extensible Markup Language (XML), JavaScript Object Notation (JSON), and/or any other suitable or desired format. In some embodiments, platform 110 may provide a special purpose application programming interface (API) which defines the manner in which user system(s) 130 and/or external system(s) 140 may interact with the platform 110 to carry out certain aspects of the systems and method disclosed herein. Thus, user system(s) 130 and/or external system(s) 140 (which may themselves be servers), can define their own special purpose user interfaces, and rely on, e.g., a web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein.

In one aspect, client application 132 may be “thin,” in which case processing is primarily carried out server-side by server application 112 on platform 110. A basic example of a thin client application 132 is a browser application, which simply requests, receives, and renders content at user system(s) 130, while server application 112 on platform 110 is responsible for generating the content and managing database functions. Alternatively, the client application 132 may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application(s) 132 both perform processing), can comprise one or more executable software modules that implement one or more of the processes, methods, or functions of the application described herein.

User system 130 may further comprise, be communicatively coupled with, or otherwise have access to one or more sensor(s) 136. For example, user system 130 may comprise a camera 136 that is configured to capture still digital images and digital video content and store the digital media content in local database 134 such that application 132 can process the video content and/or send the video content to the platform 110. Alternatively, or in addition, user system 130 may comprise a sensor 136 that is configured to capture other sensor information such as ambient temperature, humidity, or moisture content of goods or of a container holding goods and provide the sensor information to application 132 for processing and/or delivery to platform 110.

External system 140 may further comprise, be communicatively coupled with, or otherwise have access to one or more sensor(s) 146. For example, external system 140 may comprise a camera 146 that is configured to capture still digital images and digital video content and store the digital media content in local database 144 such that application 142 can process the video content and/or send the video content to the platform 110. Alternatively, or in addition, external system 140 may comprise a sensor 146 that is configured to capture other sensor information such as ambient temperature, humidity, or moisture content of goods or of a container holding goods and provide the sensor information to application 142 for processing and/or delivery to platform 110.

### 1.2. Example Processing Device

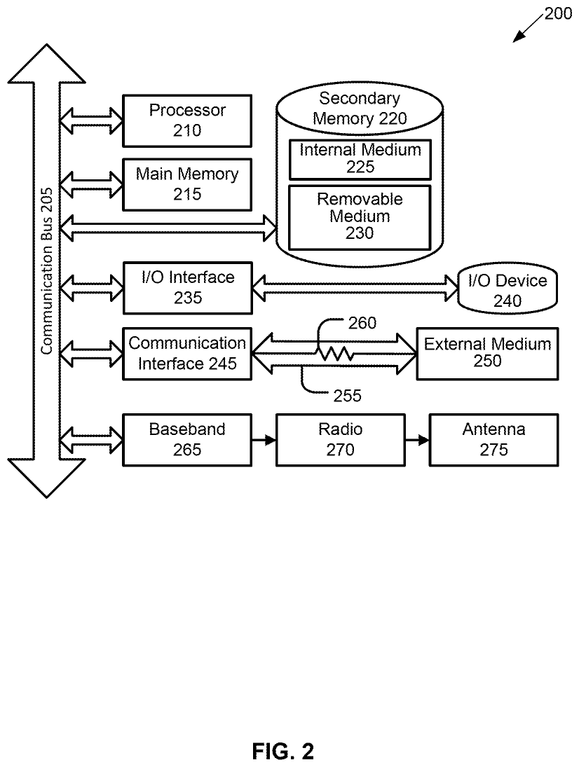

FIG. 2 is a block diagram illustrating an example special purpose wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other special purpose processing devices described herein. System 200 can be a special purpose server or a special purpose personal computer, or any other special purpose processor-enabled device that is capable of wired or wireless data communication and configured to carry out certain aspects of the systems and method disclosed herein such as sensor data collection and execution of algorithms disclosed herein. Other special purpose computer systems and/or architectures may be also used, as will be clear to those skilled in the art, as long as they are capable of wired or wireless data communication and configured to carry out certain aspects of the systems and method disclosed herein.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 245, which allows software and data to be transferred from external storage medium 250 to system 200. Examples of external storage medium 250 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 245. Communication interface 245 allows software and data to be transferred between system 200 and external devices (e.g. printers), networks, or other information sources. For example, computer software or executable code may be transferred to system 200 from a network server (e.g., platform 110) via communication interface 245. Examples of communication interface 245 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 245 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 245 are generally in the form of electrical communication signals 260. These signals 260 may be provided to communication interface 245 via a communication channel 255. In an embodiment, communication channel 255 may be a wired or wireless network (e.g., network(s) 120), or any variety of other communication links. Communication channel 255 carries signals 260 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 245 and stored in main memory 215 and/or secondary memory 220. Such computer programs, when executed, enable system 200 to perform the various functions of the disclosed embodiments as described elsewhere herein.

In this description, the term “computer-readable medium” is used to refer to any special purpose non-transitory computer-readable storage media used to provide computer-executable code and/or other data to or within system 200 to carry out certain aspects of the systems and method disclosed herein. Examples of such media include main memory 215, secondary memory 220 (including internal medium 225, removable medium 230, and external storage medium 250), and any peripheral device communicatively coupled with communication interface 245 (including a network information server or other network device). These special purpose non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 245. In such an embodiment, the software is loaded into system 200 in the form of electrical communication signals 260. The software, when executed by processor 210, causes processor 210 to at least perform one or more of the processes and functions described elsewhere herein.

In an embodiment, I/O interface 235 provides an interface between one or more components of system 200 and one or more input and/or output devices 240. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), head mounted displays (HMDs), and/or the like. In some cases, an input and output device 240 may be combined, such as in the case of a touch panel display (e.g., in a smartphone, tablet, or other mobile device).

In an embodiment, the I/O device 240 may be any type of external or integrated display and may include one or more discrete displays that in aggregate form the I/O device 240. The I/O device 240 may be capable of 2D or 3D presentation of visual information to a user of the system 200. In one embodiment, the I/O device 240 may be a virtual reality or augmented reality device in the form of an HMD worn by the user so the user may visualize the presentation of information in 3D.

System 200 may also include optional wireless communication components that facilitate wireless communication over a voice network and/or a data network (e.g., in the case of user system 130). The wireless communication components comprise an antenna system 275, a radio system 270, and a baseband system 265. In system 200, radio frequency (RF) signals are transmitted and received over the air by antenna system 275 under the management of radio system 270.

In an embodiment, antenna system 275 may comprise one or more antennae and one or more multiplexors (not shown) that perform a switching function to provide antenna system 275 with transmit and receive signal paths. In the receive path, received RF signals can be coupled from a multiplexor to a low noise amplifier (not shown) that amplifies the received RF signal and sends the amplified signal to radio system 270.

In an embodiment, radio system 270 may comprise one or more radios that are configured to communicate over various frequencies. In an embodiment, radio system 270 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 270 to baseband system 265.

If the received signal contains audio information, then baseband system 265 decodes the signal and converts it to an analog signal. Then the signal is amplified and sent to a speaker (e.g., I/O device 240). Baseband system 265 also receives analog audio signals from a microphone (e.g., I/O device 240). These analog audio signals are converted to digital signals and encoded by baseband system 265. Baseband system 265 also encodes the digital signals for transmission and generates a baseband transmit audio signal that is routed to the modulator portion of radio system 270. The modulator mixes the baseband transmit audio signal with an RF carrier signal, generating an RF transmit signal that is routed to antenna system 275 and may pass through a power amplifier (not shown). The power amplifier amplifies the RF transmit signal and routes it to antenna system 275, where the signal is switched to the antenna port for transmission.

Baseband system 265 is also communicatively coupled with processor 210, which may be a central processing unit (CPU). Processor 210 is configured with read and write access to data storage areas including main memory 215 and secondary memory 220. Processor 210 is preferably configured to execute instructions (i.e., computer programs, such as the disclosed application, or software modules) that can be stored in main memory 215 or secondary memory 220. Computer programs can also be received from baseband system 265 and stored in main memory 215 or in secondary memory 220, or executed upon receipt. Such computer programs, when executed, enable system 200 to perform the various functions of the disclosed embodiments.

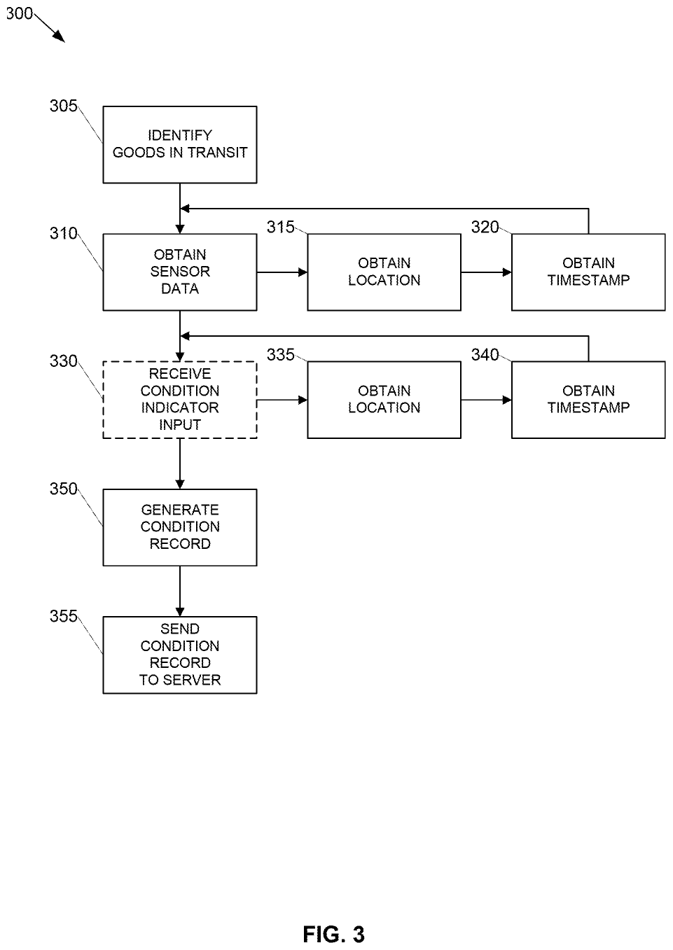

FIG. 3 is a flow diagram illustrating an example process 300 for generating a condition record according to an embodiment of the invention. In one aspect, the process of FIG. 3 may be carried out by the system described with respect to FIG. 1 in combination with one of more processing devices described with respect to FIG. 2 that may be executing the algorithm described with respect to FIG. 3.

In one aspect, a condition record is a data structure that includes a plurality of customizable data fields that can be activated for inclusion in the condition record or deactivated for exclusion from the condition record. For example, the condition record data structure may have one hundred data fields but in a particular instance, the condition record may be customized to deactivate ninety data fields such that the user system is more efficient in its use of the condition record by eliminating the need to carry data payloads for ninety additional data fields and by eliminating the need to evaluate data payloads for ninety additional data fields.

Advantageously, the plurality of customizable data fields also have customizable labels than can be configured to describe the data payload. For example, a first customizable data field may be customized to be “pallet number” such that the first customizable data field in the condition record is configured to carry a data payload that identifies the pallet number for the goods in transit.

Initially, at 305 the system identifies goods that are in transit. Goods may be individual items or a collection of individual items placed in a container or a collection of containers of individual items bound together. For example, in one aspect, goods may comprise a collection of boxes, each including a plurality of individual items, the boxes shrink wrapped together on a pallet. Identification of the goods may be accomplished by, e.g., scanning a barcode applied to individual goods or applied to a container housing the individual goods or applied to a collection of containers bound together such as a shrink wrapped pallet of containers of individual items. Alternatively, the goods may have a custom label applied to them or they may be uniquely identifiable by their nature.

Next, at 310 the system obtains sensor data corresponding to the identified goods. In one aspect, sensor data may be a digital image of the goods captured by a user device. Alternatively, or in combination, sensor data may include a video of the goods showing all sides of the goods or a plurality of sides of the goods. Sensor data may also include, for example, the temperature of the goods or the ambient temperature of the environment the goods are in. Sensor data may also include the weight of the goods, the color of the goods, the moisture content of the goods, the moisture content of a container housing the goods, and many other items of environmental information related to the goods.

Next, for each piece of sensor data that is obtained, the system also obtains, at 315, a location corresponding to the piece of sensor data, and at 320, a timestamp corresponding to the piece of sensor data.

In one aspect, location data may be obtained as global positioning system (GPS) coordinates or latitude/longitude coordinates or any other global or local coordinate system measurements that identify the location of the goods with respect to a predetermined route that the goods will follow between an origination point and a destination point. Advantageously, the predetermined route may include a plurality of optional routes and may also be dynamically updated to provide flexibility for real time alteration of the delivery route, for example due to weather events, traffic events, missed connections, and the like.

In one aspect, the timestamp may be the time that a digital image of the goods was captured by a camera or time start time or end time of a digital video of the goods captured by a camera. The timestamp may also be the time that temperature was measured or otherwise obtained or the time that a moisture content was measured or otherwise obtained.

Next, at 330, the system optionally receives a condition indicator via a user input. The user input may be received by the system via a customized user interface on a user device. The user input comprises at least a portion of the condition indictor and may, for example, be a voice recording or a typed note or other information in a variety of formats provided by a user via a user system.

Next, for each condition indicator that is received, the system also obtains, at 335, a location corresponding to the condition indicator, and at 340, a timestamp corresponding to the condition indicator.

In one aspect, the location may be the location of the user system that received the condition indicator and the timestamp may be the time that the condition indicator was received by the user system.

Next, at 350, the system generates a condition record. Advantageously, the condition record may include a plurality of pieces of sensor data and their corresponding locations and timestamps and a plurality of condition indicators and their corresponding locations and timestamps.

In one aspect, a condition record may comprise all of the information collected corresponding to the goods at a particular waypoint (e.g., a warehouse) in the predetermined route of the goods. Alternatively, a plurality of condition records for the goods may be generated at a particular waypoint (e.g., a warehouse).

In one aspect, the system provides significant configurability regarding the content and the labeling of content that may be included in the condition record. For example, a default configuration of a condition record may include data fields including a bill of laden number, a load number, an order number, a carrier name, a trailer number, a comments field, and an exceptions field. Advantageously, a particular user of the system may configure the condition records for its goods in transit to exclude one or more of those default fields. Alternatively, a particular user of the system may also configure the condition records for its goods in transit to change the label associated with one or more of the default fields while also excluding one or more of the default fields. Such flexibility allows different users to customize the system for the specific types goods in transit for the respective user while the system continues to operate in the same fashion.

Next, at 355, the system sends the condition record to the server where it can be stored in association with the identified goods and all other condition records generated for the identified goods along the predetermined route between the origination point and the destination point.

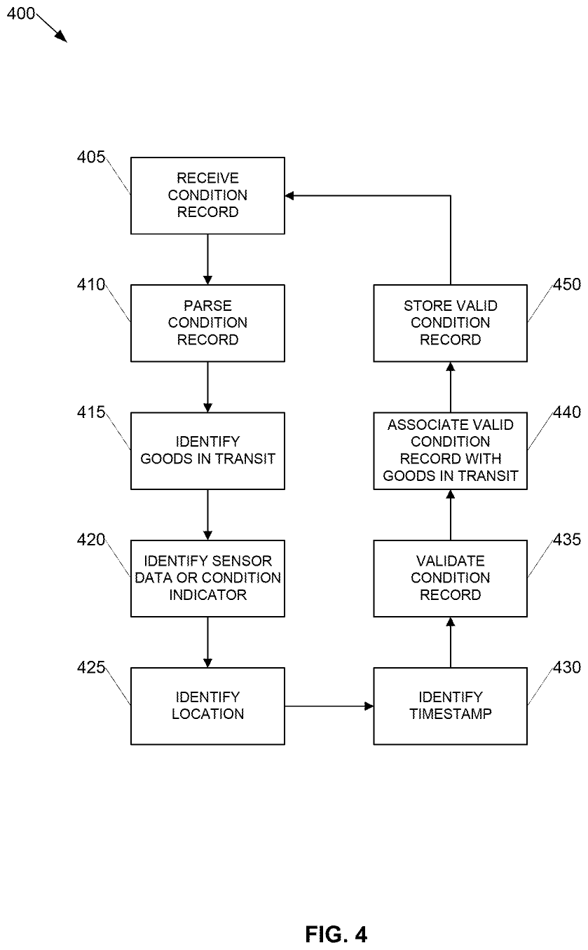

FIG. 4 is a flow diagram illustrating an example process 400 for validating and storing condition records according to an embodiment of the invention. In one aspect, the process of FIG. 4 may be carried out by the system described with respect to FIG. 1 in combination with one of more processing devices described with respect to FIG. 2 that may be executing the algorithm described with respect to FIG. 4.

Initially, at 405 the system receives a condition record. A condition record comprises at least an identification of the goods in transit and one or more sets of information corresponding to the identified goods in transit including: a piece of sensor data or a condition indicator, a location, and a timestamp.

Next, at 410, the system parses the condition record and at 415 the system identifies the goods in transit. Next, at 420, the system identifies the sensor data or condition indicator that is part of a first set of information corresponding to the identified goods in transit. Next, at 425 the system identifies the location at which the sensor data or condition indicator was obtained. Next, at 430 the system identifies the timestamp at which the sensor data or condition indicator was obtained.

Next, at 435, the system validates the condition record. In one aspect, validating the condition record may include analyzing the location and timestamp corresponding to the sensor data or condition indicator to determine if the location and timestamp substantially correlate with a predetermined route for the goods in transit. For example, if the location is a shipyard in Longbeach, CA and the timestamp is 3 AM on Mar. 16, 2023 and the predetermined route for the goods in transit indicates that the goods will be received at the Longbeach port between 1 AM and 5 AM then the system determines that the condition record is valid.

Next, at 440, the system associates the validate condition record with the goods in transit and at 450 the system stores the validated condition record, for example in a database or memory, or other data storage device that houses one or more validated condition records corresponding to the same goods in transit.

After the validated condition record is stored, the system may repeat the process for the next condition record that is received. Advantageously, the next condition record may correspond to the same goods in transit or may correspond to entirely different goods in transit. In one aspect, the system may receive, parse, validate, and store thousands or millions of condition records in parallel across multiple servers to accommodate the huge amount of goods in transit at any given time.

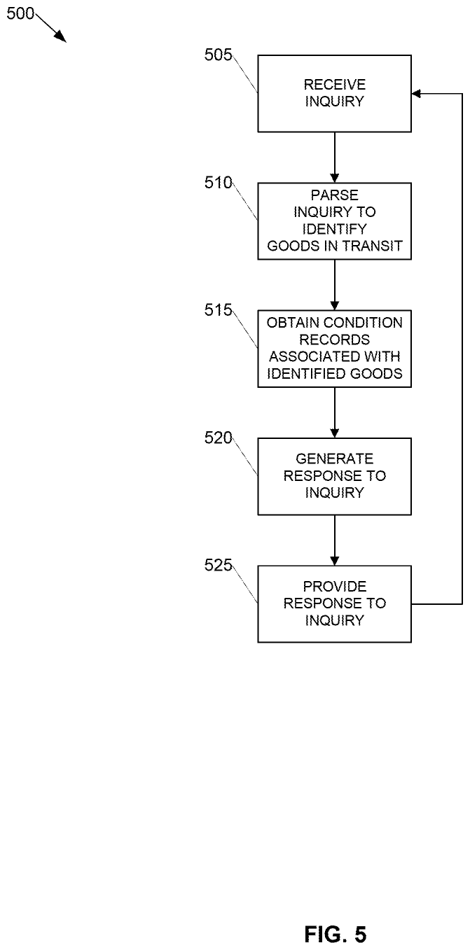

FIG. 5 is a flow diagram illustrating an example process 500 for responding to an inquiry about goods in transit according to an embodiment of the invention. In one aspect, the process of FIG. 5 may be carried out by the system described with respect to FIG. 1 in combination with one of more processing devices described with respect to FIG. 2 that may be executing the algorithm described with respect to FIG. 5.

Initially, at 505 the system receives an inquiry. The inquiry may be received via a user interface provided by a server, for example a server providing a software as a service search capability so that interested parties may obtain information about goods that are presently in transit or goods that were previously in transit.

Next, at 510, the system parses the inquiry to identify the goods in transit to which the query pertains. The system may also validate the request, for example to confirm that the request originates from a current user.

Next, at 515, the system obtains one or more condition records associated with the identified goods in transit. In one aspect, the system may obtain one or more condition records from a database or a memory or other data storage device.

Next, at 520, the system generates a response to the inquiry. For example, a response to the inquiry may range from confirmation that the goods arrived at the destination point of the predetermined route. In one aspect, a response to the inquiry may also include the condition of the goods when they departed the origination point, arrived at the destination point, and all arrivals and departures from transfer points in between. For example, the condition of the goods may be provided by including in the response to the inquiry one or more digital images of the goods and/or one or more videos of the goods at any point from the origination point to the destination point. The condition of the goods may also be provided by including in the response to the inquiry one or more condition indicators that were generated at the origination point, the destination point, and all transfer points in between, such as an audio note from an inspector with a voice memo stating that the goods in transit were provided or received in a particular condition.

Advantageously, a rich amount of detailed information about the goods in transit may be obtained from the various condition records corresponding to the goods in transit that were stored by the system as the goods traversed the predetermined route from the origination point to the destination point. Some or all of this information may be included in the generated response to the inquiry.

Next, at 525, the system provides a response to the inquiry. In one aspect, the response may be presented on a user interface for viewing by a user. Alternatively, the response may be transmitted over one or more networks or sent via a digital service such as an email service or web service.

After the response to the inquiry is provided, the system may repeat the process for the next inquiry that is received. Advantageously, the system may receive and respond to thousands or millions of inquiries in parallel across multiple servers to accommodate requests corresponding to the huge amount of goods in transit over time.

### User Interfaces

In one aspect, the infrastructure 100 described with respect to FIG. 1 and the platform 110 and user system 130 provide alternative user interfaces. The user system 130 provides a mobile application type of user interface that may be executed on one or more mobile devices such as mobile phones, tablet computers, or other devices including ruggedized commercial mobile devices used in warehouses and other appropriate locations. The mobile application allows users to generate information and data about the condition of goods moving through the supply chain and provide that information and data to the platform 110. The platform 110 provides a dashboard type of user interface that allows one or more users to access, retrieve and share condition records and other data that has been collected by the infrastructure 100 and saved in a database or other memory, for example, a data storage area accessible by the platform 110. Such information and data and condition records may be generated by a user system 130 or an external system 140. The dashboard type of user interface advantageously provides a user with access to various administrative and setup tools that allow a user to configure the various aspects of the overall functionality provided by the platform 110 to meet specific needs.

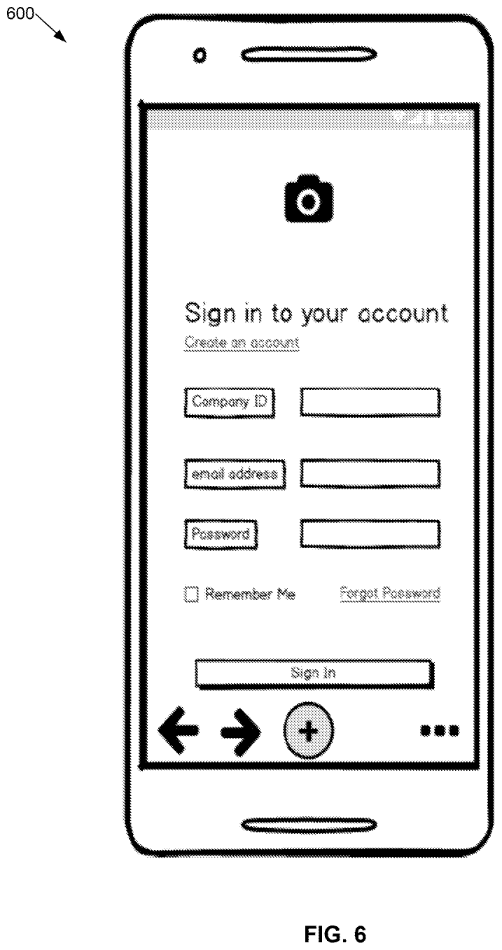

FIGS. 6-16 are screen shot diagrams illustrating an example user interface on a mobile device such as user system 130 according to an embodiment of the invention.

FIG. 6 is an example mobile application type of user interface login screen.

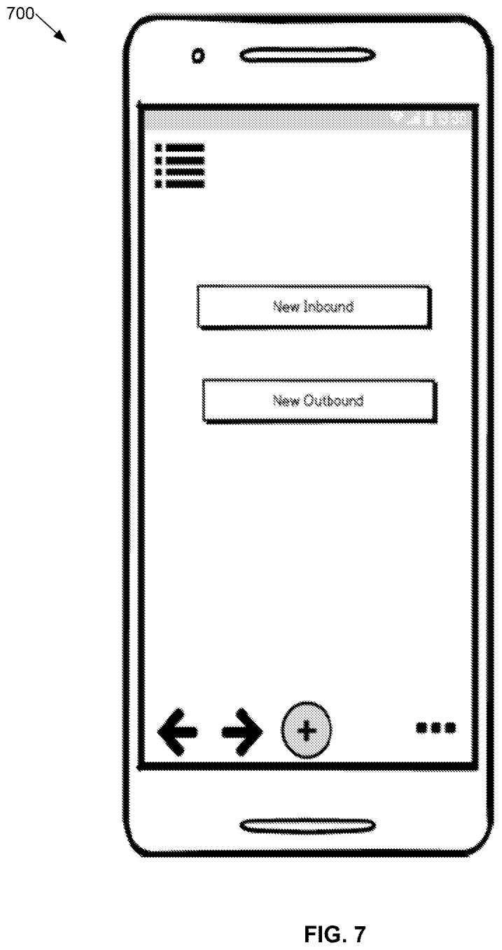

FIG. 7 is an example mobile application type of user interface home screen allowing a user to initiate a data capture activity (e.g., a condition record). In one aspect, a data capture activity is to create a new outbound activity in which one or more condition records are generated to capture the condition of goods in transit as the goods in transit are prepared for a change in possession from a shipper to a transporter or receiver. In another aspect, a data capture activity is to create a new inbound activity in which one or more condition records are generated to capture the condition of goods in transit as the goods in transit are received from a shipper or transporting party. Additional activity types may include a new pickup activity or a new delivery activity that may be more considered appropriate for a trucking company or carrier company.

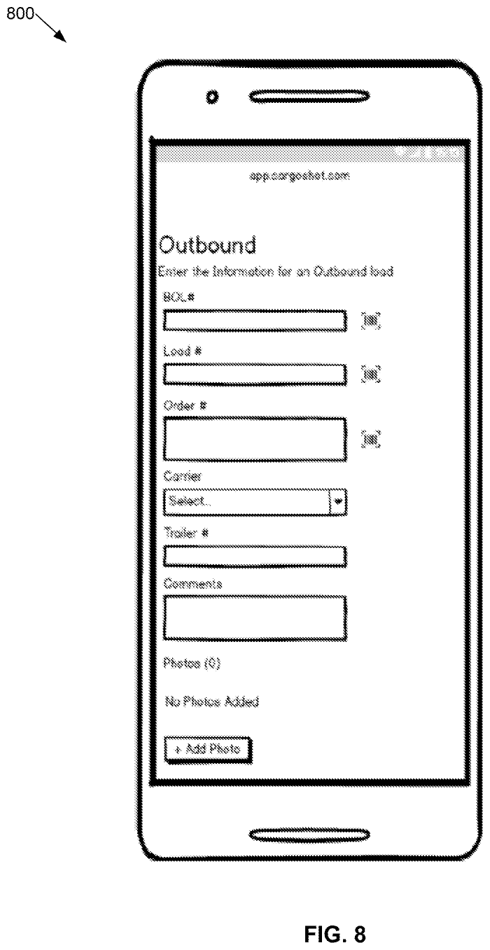

FIG. 8 is an example mobile application type of user interface outbound activity data capture screen including specific data fields and labels configured to receive input from a user when generating a new outbound activity condition record. As previously described, the presence of the specific data fields and the labels applied to the specific data fields are customizable by an administrative user. The content of the data fields can be provided by a mobile application user through manual text entry, drop down menu selection, barcode scanning, and the like. Data entry/providing data may also include the ability to add digital images and videos of goods in transit as well as other items.

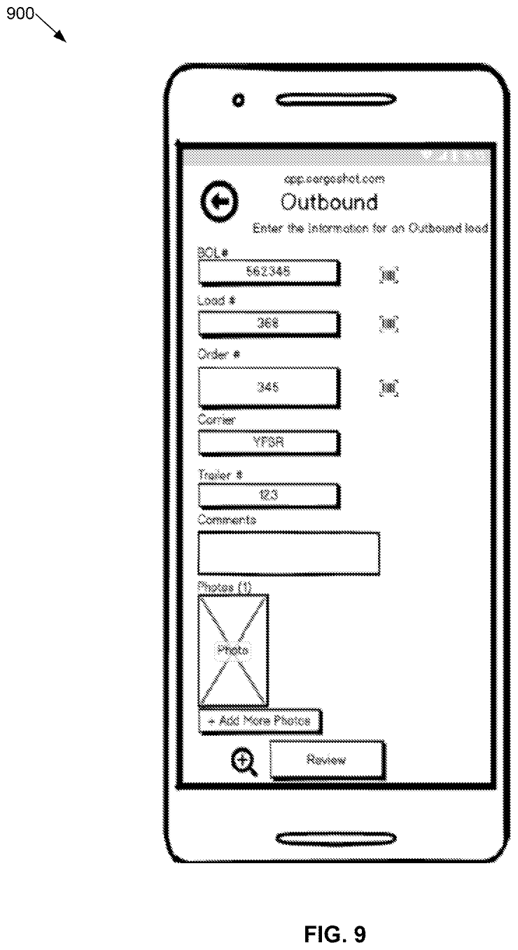

FIG. 9 is an example mobile application type of user interface outbound activity data capture screen with populated data fields and an attached digital image. In one aspect, the attached digital image may be a digital photograph of the particular goods in transit associated with the Order #or a digital photograph of other items.

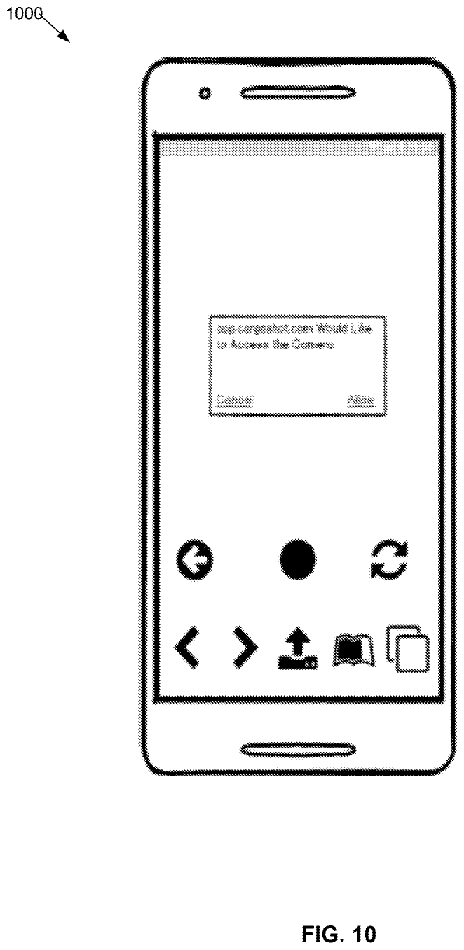

FIG. 10 is an example mobile application type of user interface illustrating the mobile application asking the user for permission to access the user system's camera.

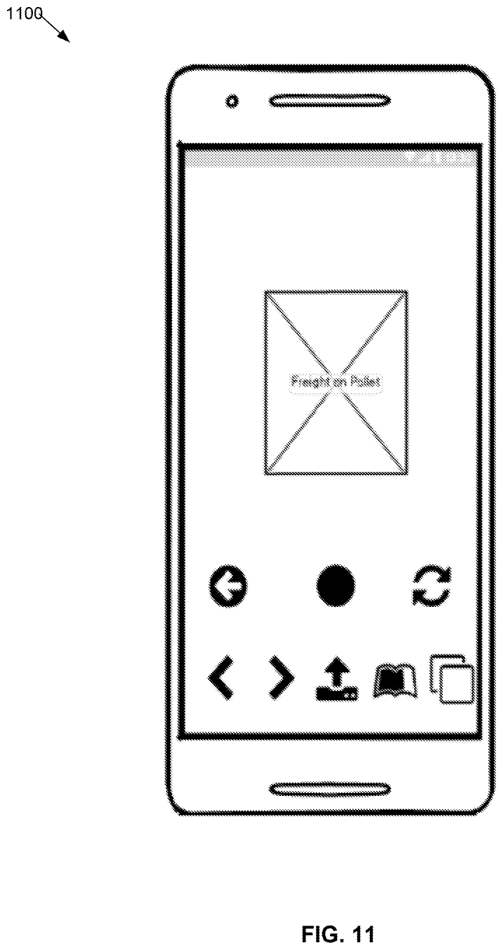

FIG. 11 is an example mobile application type of user interface illustrating an example of using a user system's camera to capture a digital image.

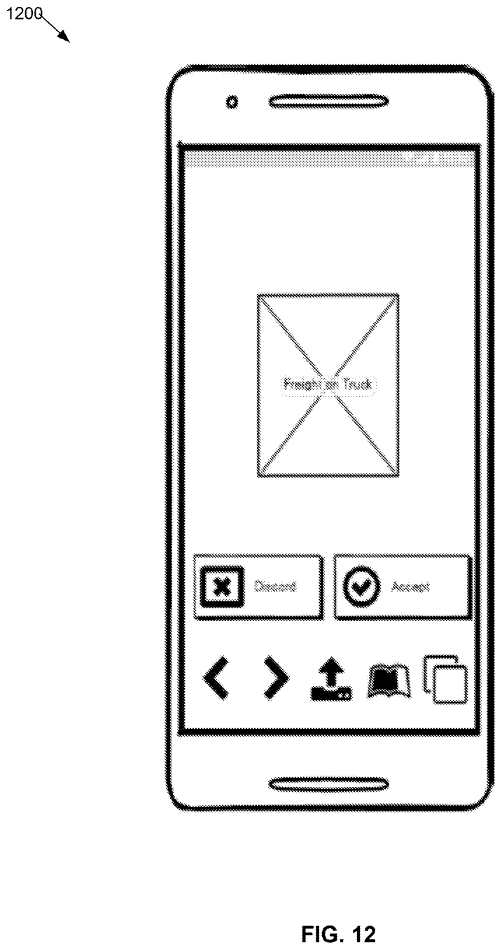

FIG. 12 is an example mobile application type of user interface illustrating an example of the mobile application prompting the user to accept or discard a digital image captured by the user system.

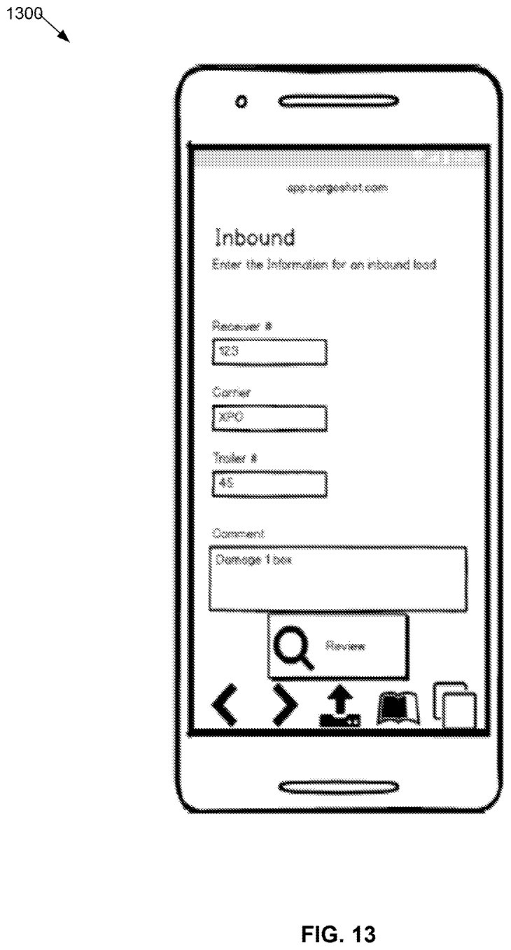

FIG. 13 is an example mobile application type of user interface illustrating an example of the inbound goods in transit data capture screen including data fields and labels that can be customized by an administrative user as discussed above. The data in the illustrated fields can be provided by a user through the mobile application user interface by way of manual text entry, audio recording and translation to text, barcode scanning, and the like.

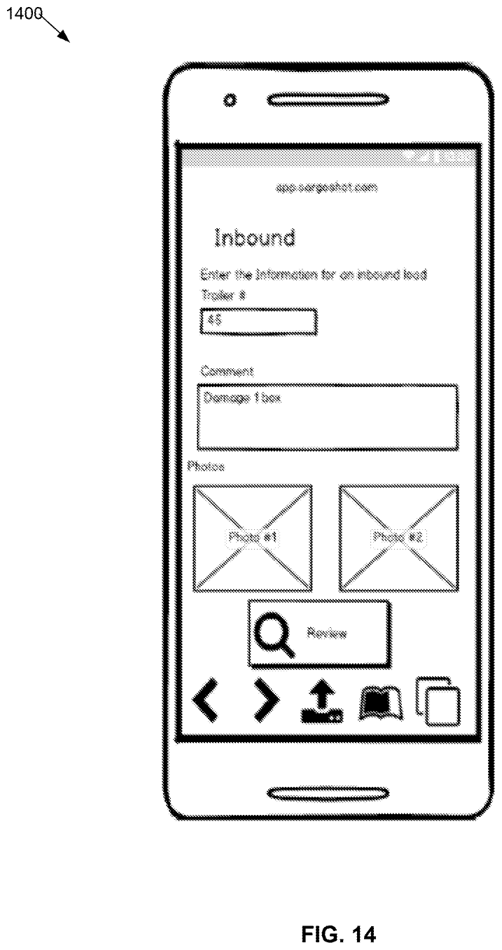

FIG. 14 is an example mobile application type of user interface illustrating an example inbound goods in transit review screen whereby a user can confirm that the desired data and digital images has been correctly entered.

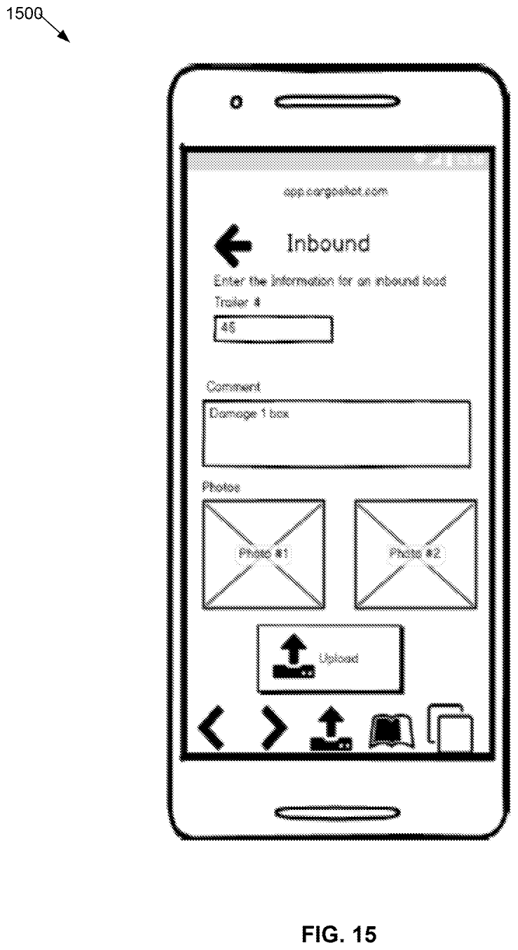

FIG. 15 is an example mobile application type of user interface illustrating an example inbound goods in transit screen whereby a user can initiate the upload of a condition record generated by the mobile application on the user system to provide the condition record to the platform 110 for storage in a database or data storage system.

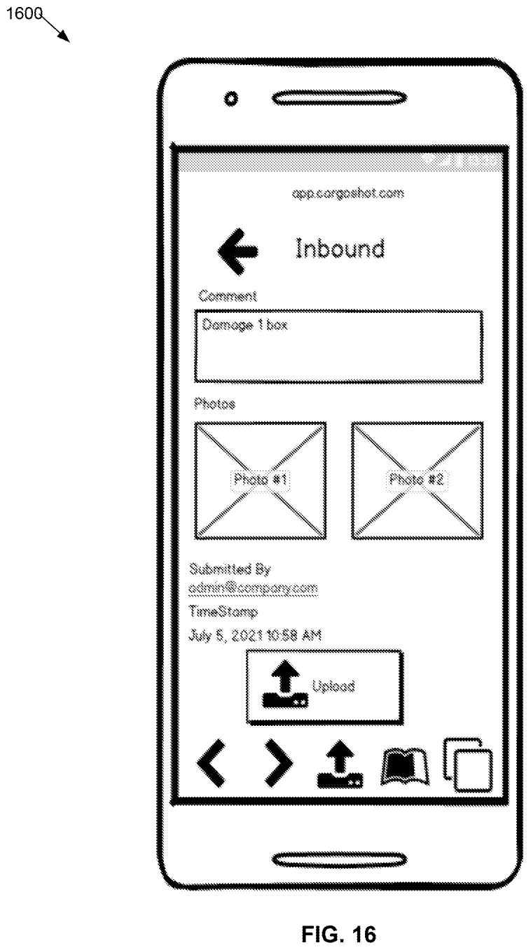

FIG. 16 is an example mobile application type of user interface illustrating an example inbound goods in transit screen whereby a user whose identity is displayed on the screen can initiate the upload of a condition record generated by the mobile application on the user system to provide the condition record to the platform 110 for storage in a database or data storage system.

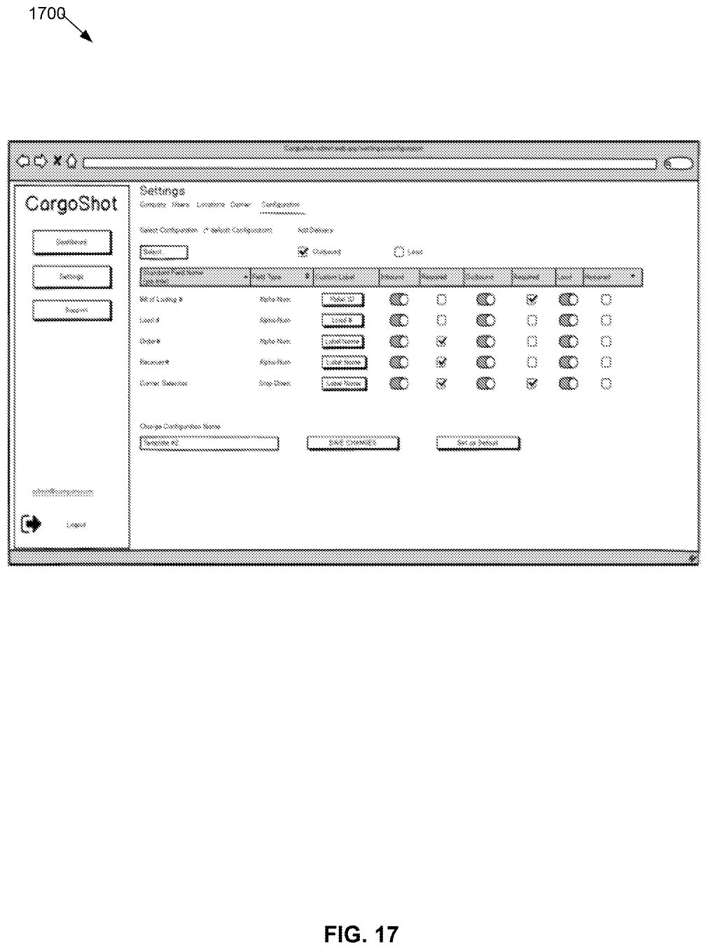

FIGS. 17-24 are screen shot diagrams illustrating an example user interface on a server system such as platform 110 according to an embodiment of the invention.

FIG. 17 is an example user interface on a server system illustrating an example of the settings→configuration functionality that can be used to customize the labels of data entry fields that appear on the mobile application, select which data entry fields are displayed on the mobile application for each activity type, determine which data entry fields are required or optional, name and save the combination of labeled data entry fields as a selected configuration, and set a selected configuration as the default configuration.

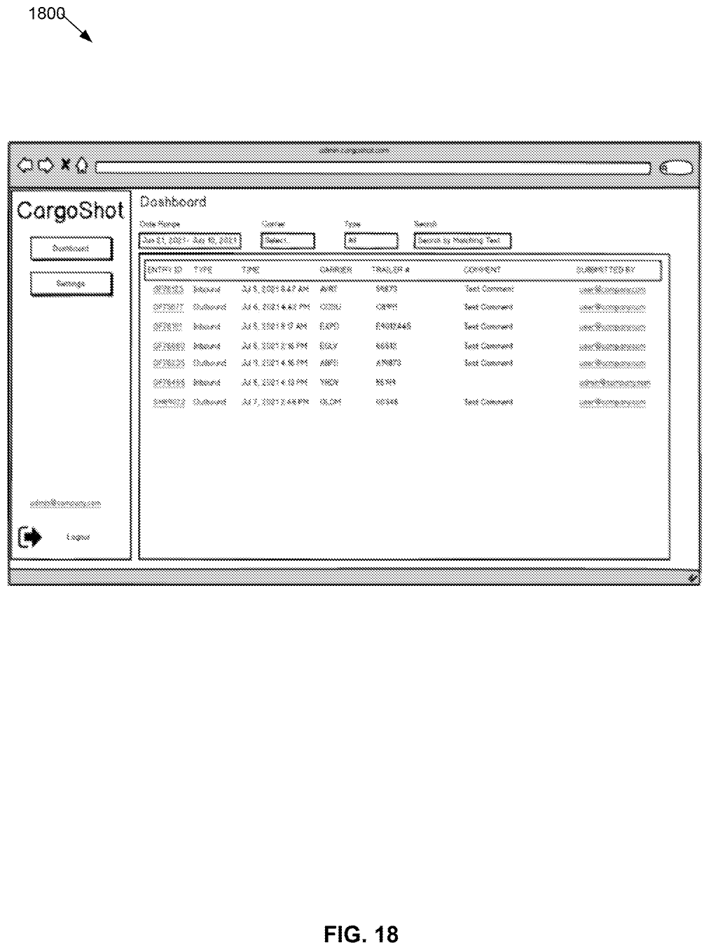

FIG. 18 is an example user interface on a server system illustrating an example of a dashboard view that allows a user to access and retrieve condition records and digital images that have been saved by the platform 110.

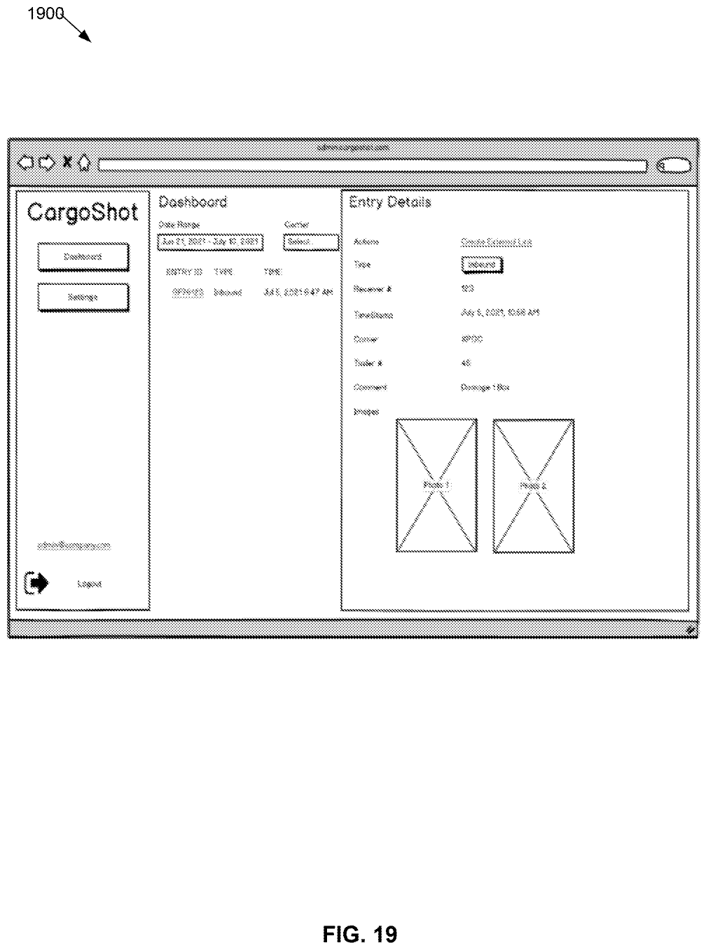

FIG. 19 is an example user interface on a server system illustrating an example entry details screen where a particular goods in transit (e.g., a particular customer order) may be selected in the dashboard of FIG. 18 and the details of the particular order are expanded to provide more detail.

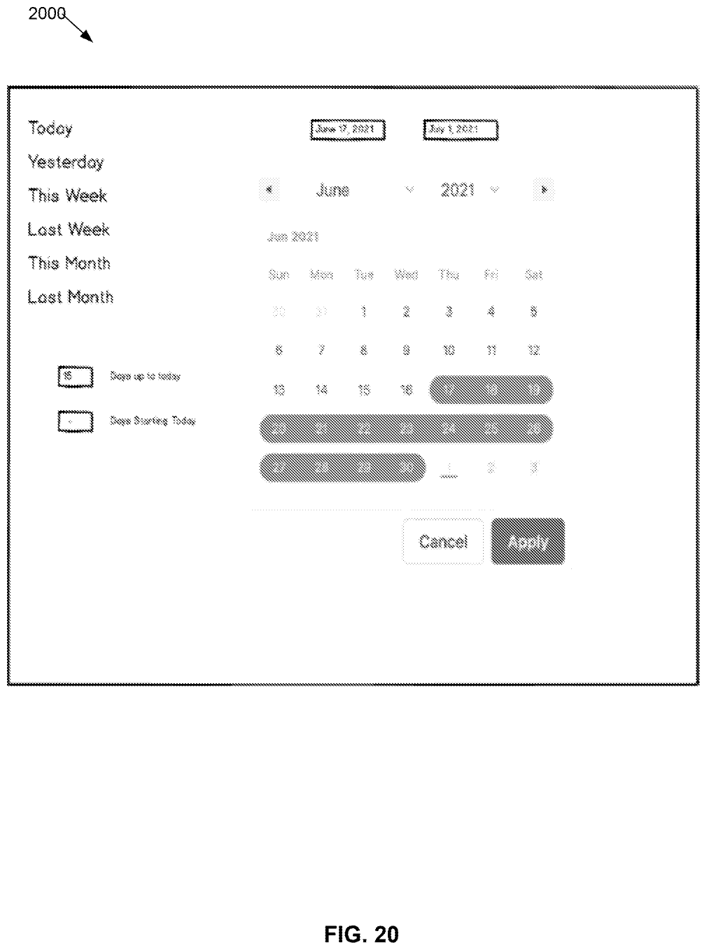

FIG. 20 is an example user interface on a server system illustrating an example of multiple options to filter condition records shown in the dashboard view of FIG. 18 by various date windows.

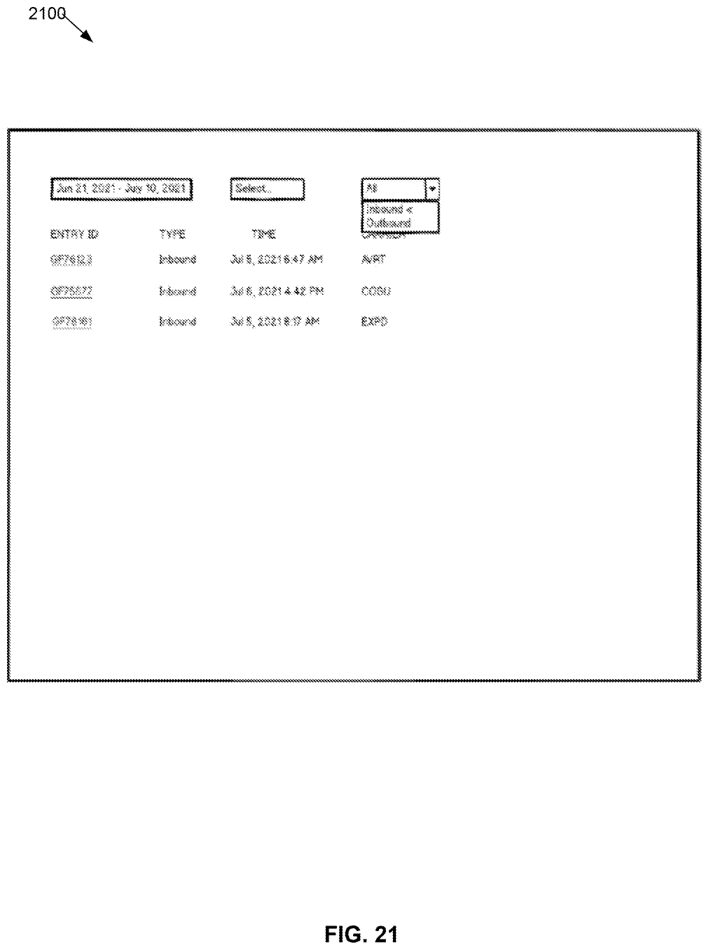

FIG. 21 is an example user interface on a server system illustrating an example of filtering condition records shown in the dashboard view by activity type to show only outbound activity condition records or show only inbound activity condition records.

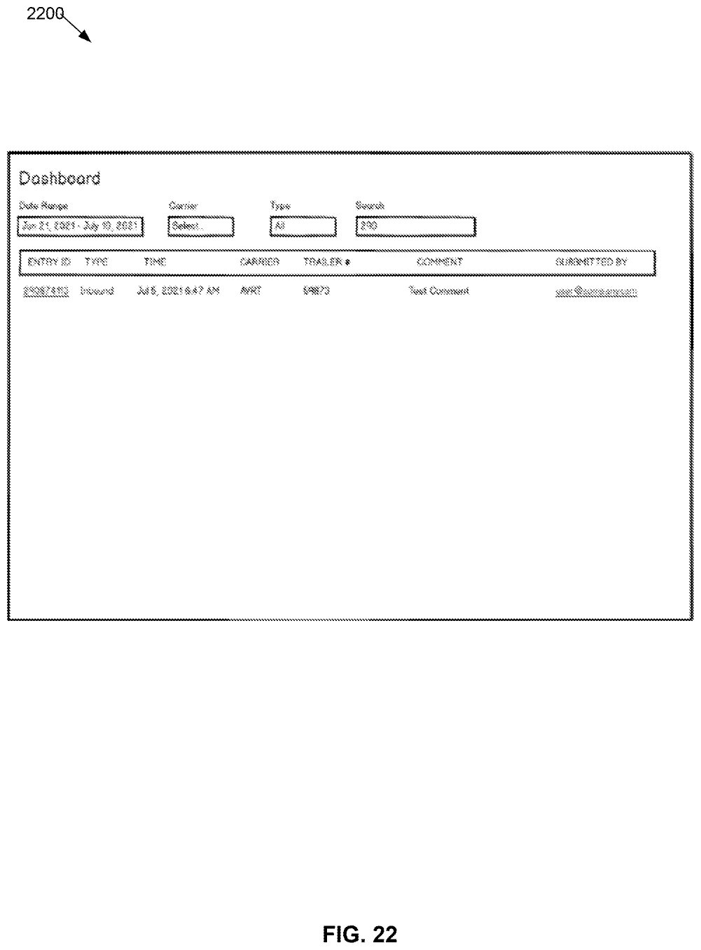

FIG. 22 is an example user interface on a server system illustrating an example of filtering condition records through a free text search function.

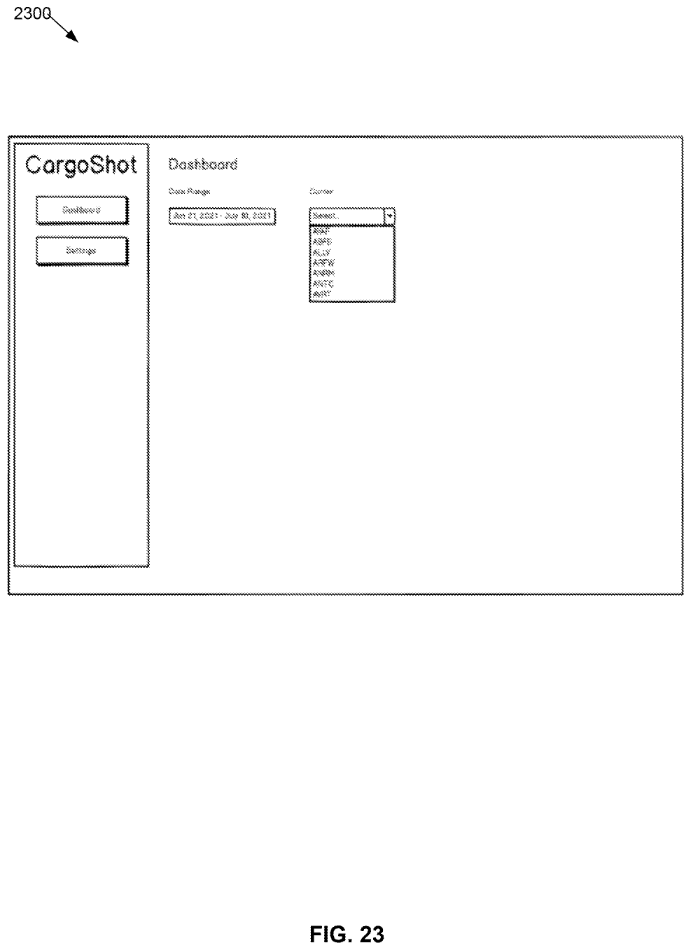

FIG. 23 is an example user interface on a server system illustrating an example of filtering condition records by carrier type. In one aspect, the carrier type can be selected from a dropdown menu.

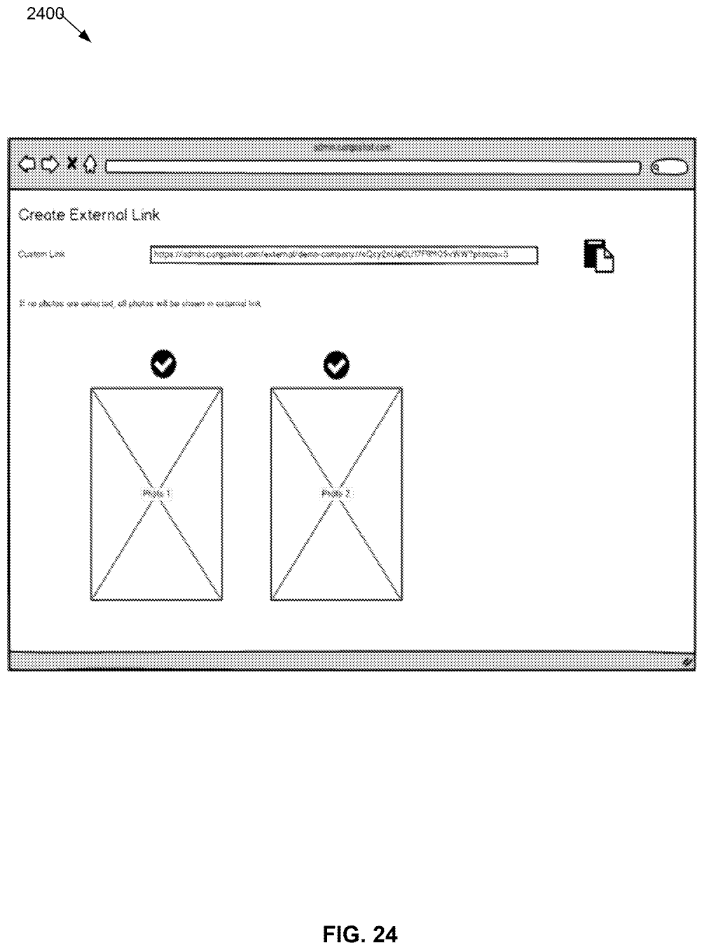

FIG. 24 is an example user interface on a server system illustrating an example of functionality enabling the creation of an external link that can be used to share selected condition records and digital images internally or externally by sharing the generated link with intended recipients of the shared condition records and digital images.

### Example Use Cases

One example use case for the present system provides greater accountability in determining responsibility for goods in transit that are mishandled or damaged. In operation, such mishandling or damage may result in substantial costs related to fines, penalties, and destruction of goods. The system provides such accountability by generating and storing, for example, digital images of the goods in transit to demonstrate the condition of the goods starting at the origination point and including various intermediate points through to the destination point. Advantageously, the system allows the various parties involved in the transport of the goods in transit from the origination point to the destination point to document the condition and status of the goods in transit at each handoff of the goods in transit between parties involved in the transport of the goods in transit between the origination point and the destination point. Such documentation of the condition and status of the goods in transit allows the system to identify a narrow window along the route between the origination point and the destination point where the condition and/or status of the goods changed. For example, such documentation allows the system to determine the party that was in control of transporting the goods in transit when the goods in transit were damaged.

In one aspect, the digital images (and other related information) from the condition records can be used as proof of the condition of the goods in transit when the goods in transit were in the care of particular entity in the chain of custody of the goods in transit between the origination point and destination point. Such digital images (and other related information) can also provide significant value to the claims management process and for proving vendor compliance for all parties involved in the transport of the goods in transit between the origination point and destination point as well as the one or more insurance carriers that may have insured the goods or the parties involved in the transport of the goods in transit between the origination point and destination point.

Another example use case for the present system provides real time communication ability for users to collaborate about goods in transit. For example, goods in transit arrive at a warehouse location shrink wrapped to a pallet and a first user offloads the goods from an inbound shipment, takes a few pictures and videos of the pallet of goods, and generates one or more condition records for the goods and sends the condition records to the server for storage. Next, a second user picks up the goods with a forklift and transports them to a holding location within the warehouse. The second user also generates one or more condition records for the goods and sends the condition records to the server for storage. Unfortunately, while at the holding location, a vehicle accidentally backs into the pallet and damages the corner of the pallet and a portion of the goods on the pallet. Next, a third user picks up the goods and moves them to a staging location for outbound shipping and takes a few pictures and videos of the pallet of goods, and generates one or more condition records for the goods and sends the condition records to the server for storage.

However, the third user notices that the corner of the pallet is damaged and the shrink wrapped goods are also damaged. After the appropriate condition records are sent to the server for storage, the third user uses the system to send a real time message to all users associated with the goods in transit at the current warehouse location. The real time message initiates real time communication between various users so the users can review the condition of the goods in transit at the inbound receiving dock, in the holding location, and at the outbound shipping dock.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for monitoring goods in transit, the system comprising:
one or more user devices, each user device comprising one or more sensors configured to generate a condition record, the condition record comprising a time value, a location value, and a physical condition of goods, wherein the time value and the location value correspond to a predetermined route for transport of the goods between an origination point and a destination point;
a server device, communicatively coupled with the one or more user devices via one or more data communication networks, the server device configured to receive a first plurality of condition records from a plurality of the one or more user devices, each of the first plurality of condition records corresponding to a time value and a location value during transport of first goods on the predetermined route, the server device further configured to store the first plurality of condition records in association with the first goods and in association with each other, the server device further configured to validate each of the first plurality of condition records by analyzing the time value and the location value of the respective condition record to correlate the respective condition record to the predetermined route of the first goods; and
the server device further configured to provide at least a portion of information from the first plurality of condition records in response to a request for transit information related to the first goods.

2. The system of claim 1, wherein the condition record comprises a plurality of customizable data fields that can be activated for inclusion in the condition record or deactivated for exclusion from the condition record.

3. The system of claim 2, wherein the plurality of customizable data fields have customizable labels and a first customizable data field is configured to carry a data payload corresponding to a first customized label.

4. The system of claim 1, wherein the condition record comprises at least one of a digital image of the goods and a video including a complete perimeter of the goods.

5. (canceled)

6. The system of claim 1, wherein the predetermined route comprises a plurality of alternative routes and a plurality of intermediate points between the origination point and the destination point of each alternative route.

7. (canceled)

8. The system of claim 1, wherein the one or more user devices are further configured to receive via a user interface one or more indications corresponding to the physical condition of the goods and further configured to include the one or more indications corresponding to the physical condition of the goods in the condition record.

9. (canceled)

10. A method for a user system to generate a condition record corresponding to goods in transport between an origination point and a destination point, comprising:
identifying first goods in transit, the first goods in transit having a predetermined route for transport of the first goods in transit between a first origination point and a first destination point;
obtaining first sensor data corresponding to the identified first goods in transit, wherein the first sensor data comprises at least one of a typed note and a voice recording;
obtaining first location data corresponding to the first sensor data;
obtaining first timestamp data corresponding to the first sensor data;
generate a first condition record comprising an indicator of the identified first goods in transit, the first sensor data, the first location data corresponding to the first sensor data, and the first timestamp data corresponding to the first sensor data; and
sending the first condition record to a recipient via a data communication network.

11. The method of claim 10, wherein identifying first goods in transit comprises scanning at least one label affixed to the first goods in transit.

12. The method of claim 10, wherein the first sensor data is a digital image of the first goods in transit.

13. The method of claim 10, wherein the first location data and the first timestamp data correspond to an anticipated location and time along the predetermined route for transport of the first goods in transit between the first origination point and the first destination point.

14. The method of claim 10, further comprising:
receiving first condition indicator data corresponding to the identified first goods in transit;
obtaining first location data corresponding to the first condition indicator data;
obtaining first timestamp data corresponding to the first condition indicator data;
generate the first condition record comprising the indicator of the identified first goods in transit, the first sensor data, the first location data corresponding to the first sensor data, the first timestamp data corresponding to the first sensor data, the first condition indicator data, the first location data corresponding to the first condition indicator data, and the first timestamp data corresponding to the first condition indicator data; and
sending the first condition record to a recipient via a data communication network.

15. The method of claim 14, wherein the first condition indicator data is one of an audio recording captured by a sensor of a user system and a text string received via a user interface on the user system.

16. The method of claim 10, further comprising:
identifying second goods in transit, the second goods in transit having a predetermined route for transport of the second goods in transit between a second origination point and a second destination point;
obtaining second sensor data corresponding to the identified second goods in transit;
obtaining second location data corresponding to the second sensor data;
obtaining second timestamp data corresponding to the second sensor data;
generate a second condition record comprising an indicator of the identified second goods in transit, the second sensor data, the second location data, and the second timestamp data; and
sending the second condition record to a recipient via a data communication network.

17. The method of claim 16, wherein identifying second goods in transit comprises scanning at least one label affixed to the second goods in transit.

18. The method of claim 16, wherein the second sensor data is a digital image of the second goods in transit.

19. The method of claim 16, wherein the second location data and the second timestamp data correspond to an anticipated location and time along the predetermined route for transport of the second goods in transit between the second origination point and the second destination point.

20. The method of claim 16, further comprising:
receiving second condition indicator data corresponding to the identified second goods in transit;
obtaining second location data corresponding to the second condition indicator data;
obtaining second timestamp data corresponding to the second condition indicator data;
generate the second condition record comprising the indicator of the identified second goods in transit, the second sensor data, the second location data corresponding to the second sensor data, the second timestamp data corresponding to the second sensor data, the second condition indicator data, the second location data corresponding to the second condition indicator data, and the second timestamp data corresponding to the second condition indicator data; and
sending the second condition record to a recipient via a data communication network.

21. The method of claim 20, wherein the second condition indicator data is one of an audio recording captured by a sensor of a user system and a text string received via a user interface on the user system.

22. A method for a server system to compile condition records corresponding to goods in transport between an origination point and a destination point, comprising:
receiving a first condition record comprising an indicator that identifies first goods in transit, first sensor data, first location data corresponding to the first sensor data, and first timestamp data corresponding to the first sensor data;
parsing the first condition record to identify the first goods in transit, the first sensor data, and the first location data and the first timestamp data corresponding to the first sensor data;
validating the first condition record by comparing the first location data and the first timestamp data to a predetermined route for transport of the first goods in transit between a first origination point and a first destination point to determine that the first location data and the first timestamp data correspond to a waypoint on the predetermined route;
associating the validated first condition record with the first goods in transit; and
storing the validated first condition record in a database of a server system.

23. The method of claim 22, wherein the first condition record further comprises first condition indicator data corresponding to the first goods in transit, first location data corresponding to the first condition indicator data, and first timestamp data corresponding to the first condition indicator data, and
wherein parsing the first condition record further comprises parsing the first condition record to identify the first condition indicator data, and the first location data and the first timestamp data corresponding to the first condition indicator data,
further comprising:
receiving a second condition record comprising an indicator that identifies second goods in transit, second sensor data, second location data corresponding to the second sensor data, and second timestamp data corresponding to the second sensor data;
parsing the second condition record to identify the second goods in transit, the second sensor data, and the second location data and the second timestamp data corresponding to the second sensor data;
validating the second condition record by comparing the second location data and the second timestamp data to a predetermined route for transport of the second goods in transit between a second origination point and a second destination point;
associating the validated second condition record with the second goods in transit; and
storing the validated second condition record in the database of the server system,
wherein the second condition record further comprises second condition indicator data corresponding to the second goods in transit, second location data corresponding to the second condition indicator data, and second timestamp data corresponding to the second condition indicator data, and
wherein parsing the second condition record further comprises parsing the second condition record to identify the second condition indicator data, and the second location data and the second timestamp data corresponding to the second condition indicator data.

24-29. (canceled)
